(19) United States
(12) Patent Application Publication
(10) Pub. No.: US 2006/0136697 A1
(43) Pub. Date: Jun. 22, 2006

(54) Method, system, and program for updating a cached data structure table

(76) Inventors: Gary Y. Tsao, Austin, TX (US); Hemal V. Shah, Austin, TX (US); Arturo L. Arizpe, Wimberley, TX (US)

Correspondence Address: KONRAD RAYNES & VICTOR, LLP, 315 S. BEVERLY DRIVE, # 210, BEVERLY HILLS, CA, 90212, US

(21) Appl. No.: 11/015,680

(22) Filed: Dec. 16, 2004

(51) Int. Cl. G06F 12/10

(52) U.S. Cl. 711/206; 711/118

(57) ABSTRACT

Provided are a method, system, and program for updating a cache in which, in one aspect of the description provided herein, changes to data structure entries in the cache are selectively written back to the source data structure table maintained in the host memory. In one embodiment, translation and protection table (TPT) contents of an identified cache entry are written to a source TPT in host memory as a function of an identified state transition of the cache entry in connection with a memory operation and the memory operation. Other embodiments are described and claimed.

### BACKGROUND

### Description of Related Art

In a network environment, a network adapter or controller on a host computer, such as an Ethernet controller, Fibre Channel controller, etc., will receive Input/Output (I/O) requests or responses to I/O requests initiated from the host computer. Often, the host computer operating system includes a device driver to communicate with the network controller hardware to manage I/O requests to transmit over a network. The host computer may also utilize a protocol which packages data to be transmitted over the network into packets, each of which contains a destination address as well as a portion of the data to be transmitted. Data packets received at the network controller are often stored in a packet buffer. A transport protocol layer can process the packets received by the network controller that are stored in the packet buffer, and access any I/O commands or data embedded in the packet.

For instance, the computer may employ the TCP/IP (Transmission Control Protocol/Internet Protocol) to encode and address data for transmission, and to decode and access the payload data in the TCP/IP packets received at the network controller. IP specifies the format of packets, also called datagrams, and the addressing scheme. TCP is a higher level protocol which establishes a connection between a destination and a source and provides a byte-stream, reliable, full-duplex transport service. Another protocol, Remote Direct Memory Access (RDMA) on top of TCP provides, among other operations, direct placement of data at a specified memory location at the destination.

A device driver, program or operating system can utilize significant host processor resources to handle network transmission requests to the network controller. One technique to reduce the load on the host processor is the use of a TCP/IP Offload Engine (TOE) in which TCP/IP protocol related operations are carried out in the network controller hardware as opposed to the device driver or other host software, thereby saving the host processor from having to perform some or all of the TCP/IP protocol related operations. Similarly, an RDMA-enabled Network Interface Controller (RNIC) offloads RDMA and transport related operations from the host processor(s).

The operating system of a computer typically utilizes a virtual memory space which is often much larger than the memory space of the physical memory of the computer. FIG. 1 shows an example of a typical system translation and protection table (TPT) 60 which the operating system utilizes to map virtual memory addresses to real physical memory addresses with protection at the process level.

In some known designs, an I/O device such as a network controller or a storage controller may have the capability of directly placing data into an application buffer or other memory area. An RNIC is an example of an I/O device which can perform direct data placement.

The address of the application buffer which is the destination of the RDMA operation is frequently carried in the RDMA packets in some form of a buffer identifier and a virtual address or offset. The buffer identifier identifies which buffer the data is to be written to or read from. The virtual address or offset carried by the packets identifies the location within the identified buffer for the specified direct memory operation.

In order to perform direct data placement, an I/O device typically maintains its own translation and protection table, an example of which is shown at 70 in FIG. 2. The device TPT 70 contains data structures 72a, 72b, 72c . . . 72n, each of which is used to control access to a particular buffer as identified by an associated buffer identifier of the buffer identifiers 74a, 74b, 74c . . . 74n. The device TPT 70 further contains data structures 76a, 76b, 76c . . . 76n, each of which is used to translate the buffer identifier and virtual address or offset into physical memory addresses of the particular buffer identified by the associated buffer identifier 74a, 74b, 74c . . . 74n. Thus, for example, the data structure 76a of the TPT 70 is used by the I/O device to perform address translation for the buffer identified by the identifier 74a. Similarly, the data structure 72a is used by the I/O device to perform protection checks for the buffer identified by the buffer identifier 74a. The address translation and protection checks may be performed prior to direct data placement of the payload contained in a packet received from the network or prior to sending the data out on the network. The buffers may be located in memory areas including memory windows and memory regions, each of which may also have associated data structures in the TPT 70 to permit protection checks and address translation.

In order to facilitate high-speed data transfer, a device TPT such as the TPT 70 is typically managed by the I/O device, the driver software for the device or both. A device TPT can occupy a relatively large amount of memory. As a consequence, a TPT is frequently resident in the system or host memory. The I/O device may maintain a cache of a portion of the device TPT to reduce access delays. The particular TPT entries in host memory which are cached are often referred to as the “source” entries. The TPT cache may be accessed to read or modify the cached TPT entries. Typically, a TPT cache maintained by a network controller is a “write-through” cache in which any changes to the TPT entries in the cache are also made at the same time to the source TPT entries maintained in the host memory.

The processor of the host computer may also utilize a cache to store a portion of data being maintained in the host memory. In addition to the “write-through” caching method described above, a processor cache may also utilize a “write-back” caching method in which changes to the cache entries are not “flushed” or copied back to the source data entries of the host memory until the cache entries are to be replaced with data from new source entries of the host memory.

### BRIEF DESCRIPTION OF THE DRAWINGS

Referring now to the drawings in which like reference numbers represent corresponding parts throughout:

FIG. 1 illustrates a prior art system virtual to physical memory address translation and protection table;

FIG. 2 illustrates a prior art translation and protection table for an I/O device;

FIG. 3 illustrates one embodiment of a computing environment in which aspects of the description provided herein are embodied;

FIG. 4 illustrates one embodiment of a data structure table, and a cache of an I/O device containing a portion of the data structure table, in which aspects of the description provided herein may be employed;

FIG. 5 illustrates one embodiment of operations performed to update a cached data structure table in accordance with aspects of the present description;

FIG. 6 illustrates one example of a state transition diagram illustrating transitions of states of cache entries in connection with various memory operations affecting a data structure table; and

FIG. 7 illustrates an architecture that may be used with the described embodiments.

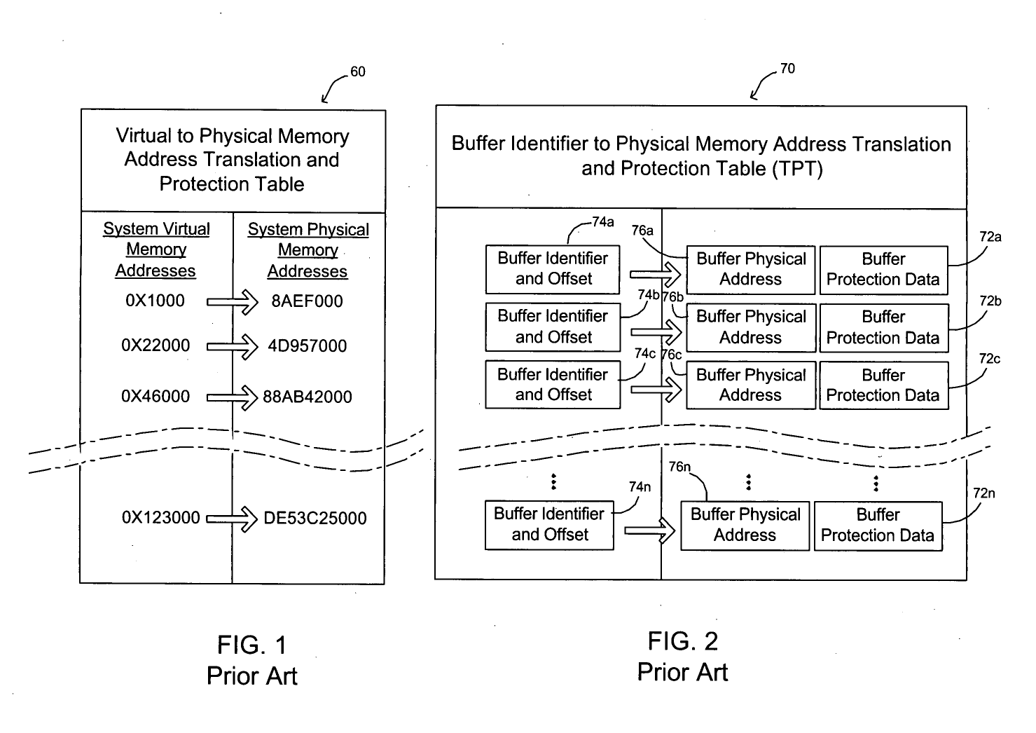

### DETAILED DESCRIPTION OF THE ILLUSTRATED EMBODIMENTS

In the following description, reference is made to the accompanying drawings which form a part hereof and which illustrate several embodiments of the present disclosure. It is understood that other embodiments may be utilized and structural and operational changes may be made without departing from the scope of the present description.

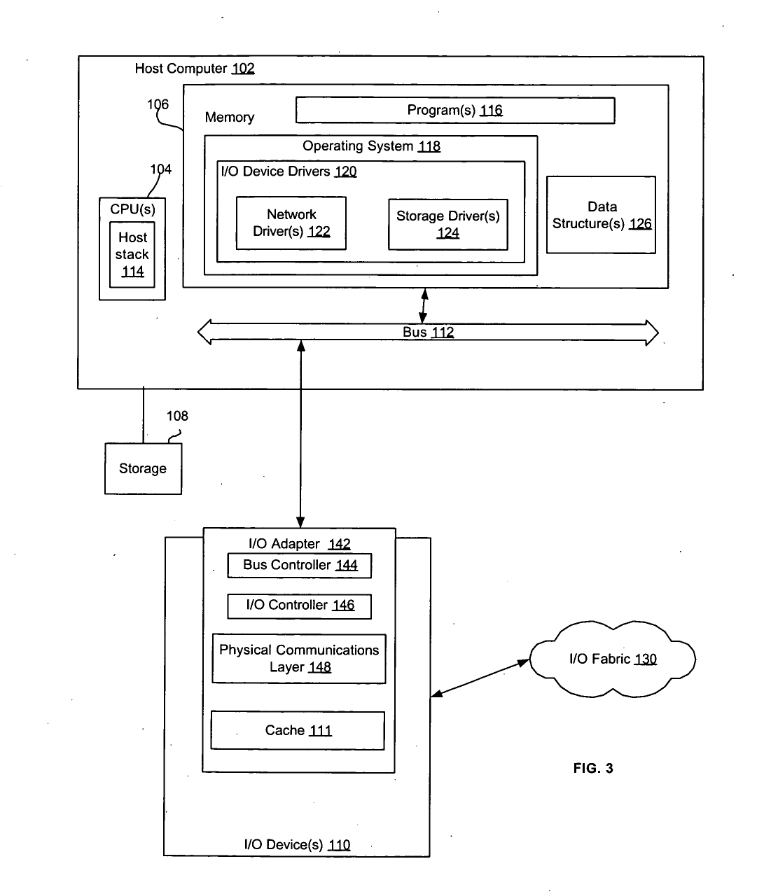

FIG. 3 illustrates a computing environment in which aspects of described embodiments may be employed. A host computer 102 includes one or more central processing units (CPUs) 104, a volatile memory 106 and a non-volatile storage 108 (e.g., magnetic disk drives, optical disk drives, a tape drive, etc.). The host computer 102 is coupled to one or more Input/Output (I/O) devices 110 via one or more busses such as a bus 112. In the illustrated embodiment, the I/O device 110 is depicted as a part of a host system, and includes a network controller such as an RNIC. Any number of I/O devices may be attached to host computer 102.

The I/O device 110 has a cache 111 which includes cache entries to store a portion of a data structure table. In accordance with one aspect of the description provided herein, as descried in greater detail below, changes to the data structure entries in the cache 111 are selectively written back to the source data structure table maintained in the host memory 106.

The host computer 102 uses I/O devices in performing I/O operations (e.g., network I/O operations, storage I/O operations, etc.). Thus, an I/O device 110 may be used as a storage controller for storage such as the storage 108, for example, which may be directly connected to the host computer 102 by a bus such as the bus 112, or may be connected by a network.

A host stack 114 executes on at least one CPU 104. A host stack may be described as software that includes programs, libraries, drivers, and an operating system that run on host processors (e.g., CPU 104) of a host computer 102. One or more programs 116 (e.g., host software, application programs, and/or other programs) and an operating system 118 reside in memory 106 during execution and execute on one or more CPUs 104. One or more of the programs 116 is capable of transmitting and receiving packets from a remote computer.

The host computer 102 may comprise any suitable computing device, such as a mainframe, server, personal computer, workstation, laptop, handheld computer, telephony device, network appliance, virtualization device, storage controller, etc. Any suitable CPU 104 and operating system 118 may be used. Programs and data in memory 106 may be swapped between memory 106 and storage 108 as part of memory management operations.

Operating system 118 includes I/O device drivers 120. The I/O device drivers 120 include one or more network drivers 122 and one or more storage drivers 124 that reside in memory 106 during execution. The network drivers 122 and storage drivers 124 may be described as types of I/O device drivers 120. Also, one or more data structures 126 are in memory 106.

Each I/O device driver 120 includes I/O device specific commands to communicate with an associated I/O device 110 and interfaces between the operating system 118, programs 116 and the associated I/O device 110. The I/O devices 110 and I/O device drivers 120 employ logic to process I/O functions.

Each I/O device 110 includes various components included in the hardware of the I/O device 110. The I/O device 110 of the illustrated embodiment is capable of transmitting and receiving packets of data over I/O fabric 130, which may comprise a Local Area Network (LAN), the Internet, a Wide Area Network (WAN), a Storage Area Network (SAN), WiFi (Institute of Electrical and Electronics Engineers (IEEE) 802.11b, published Sep. 16, 1999), Wireless LAN (IEEE 802.11b, published Sep. 16, 1999), etc.

Each I/O device 110 includes an I/O adapter 142, which in certain embodiments, is a Host Bus Adapter (HBA). In the illustrated embodiment, an I/O adapter 142 includes a bus controller 144, an I/O controller 146, and a physical communications layer 148. The cache 111 is shown coupled to the adapter 142 but may be apart of the adapter 142. The bus controller 144 enables the I/O device 110 to communicate on the computer bus 112, which may comprise any suitable bus interface, such as any type of Peripheral Component Interconnect (PCI) bus (e.g., a PCI bus (PCI Special Interest Group, PCI Local Bus Specification, Rev 2.3, published March 2002), a PCI-X bus (PCI Special Interest Group, PCI-X 2.0a Protocol Specification, published July 2003), or a PCI Express bus (PCI Special Interest Group, PCI Express Base Specification 1.0a, published April 2003), Small Computer System Interface (SCSI) (American National Standards Institute (ANSI) SCSI Controller Commands-2 (SCC-2) NCITS.318:1998), Serial ATA ((SATA 1.0a Specification, published Feb. 4, 2003), etc.

The I/O controller 146 provides functions used to perform I/O functions. The physical communication layer 148 provides functionality to send and receive network packets to and from remote data storages over an I/O fabric 130. In certain embodiments, the I/O adapters 142 may utilize the Ethernet protocol (IEEE std. 802.3, published Mar. 8, 2002) over unshielded twisted pair cable, token ring protocol, Fibre Channel (IETF RFC 3643, published December 2003), Infiniband, or any other suitable networking and storage protocol. The I/O device 110 may be integrated into the CPU chipset, which can include various controllers including a system controller, peripheral controller, memory controller, hub controller, I/O bus controller, etc.

An I/O device such as a storage controller controls the reading of data from and the writing of data to the storage 108 in accordance with a storage protocol layer. The storage protocol may be any of a number of suitable storage protocols including Redundant Array of Independent Disks (RAID), High Speed Serialized Advanced Technology Attachment (SATA), parallel Small Computer System Interface (SCSI), serial attached SCSI, etc. Data being written to or read from the storage 108 may be cached in a cache in accordance with various suitable caching techniques. The storage controller may be integrated into the CPU chipset, which can include various controllers including a system controller, peripheral controller, memory controller, hub controller, I/O bus controller, etc.

The I/O devices 110 may include additional hardware logic to perform additional operations to process received packets from the host computer 102 or the I/O fabric 130. For example, the I/O device 110 of the illustrated embodiment includes a network protocol layer to send and receive network packets to and from remote devices over the I/O fabric 130. The I/O device 110 can control other protocol layers including a data link layer and the physical layer 148 which includes hardware such as a data transceiver.

Still further, the I/O devices 110 may utilize a TOE to provide the transport protocol layer in the hardware or firmware of the I/O device 110 as opposed to the I/O device drivers 120 or host software, to further reduce host computer 102 processing burdens. Alternatively, the transport layer may be provided in the I/O device drivers 120 or other drivers (for example, provided by an operating system).

The transport protocol operations include packaging data in a TCP/IP packet with a checksum and other information and sending the packets. These sending operations are performed by an agent which may be embodied with a TOE, a network interface card or integrated circuit, a driver, TCP/IP stack, a host processor or a combination of these elements. The transport protocol operations also include receiving a TCP/IP packet from over the network and unpacking the TCP/IP packet to access the payload data. These receiving operations are performed by an agent which, again, may be embodied with a TOE, a network interface card or integrated circuit, a driver, TCP/IP stack, a host processor or a combination of these elements.

The network layer handles network communication and provides received TCP/IP packets to the transport protocol layer. The transport protocol layer interfaces with the device driver 120 or an operating system 118 or a program 116, and performs additional transport protocol layer operations, such as processing the content of messages included in the packets received at the I/O device 110 that are wrapped in a transport layer, such as TCP, the Internet Small Computer System Interface (iSCSI), Fibre Channel SCSI, parallel SCSI transport, or any suitable transport layer protocol. The TOE of the transport protocol layer 121 can unpack the payload from the received TCP/IP packet(s) and transfer the data to the device driver 120, the program 116 or the operating system 118.

In certain embodiments, the I/O device 110 can further include one or more RDMA protocol layers as well as the basic transport protocol layer. For example, the I/O device 110 can employ an RDMA offload engine, in which RDMA layer operations are performed within the hardware or firmware of the I/O device 110, as opposed to the device driver 120 or other host software.

Thus, for example, a program 116 transmitting messages over an RDMA connection can transmit the message through the RDMA protocol layers of the I/O device 110. The data of the message can be sent to the transport protocol layer to be packaged in a TCP/IP packet before transmitting it over the I/O fabric 130 through the network protocol layer and other protocol layers including the data link and physical protocol layers.

Thus, in certain embodiments, the I/O devices 110 may include an RNIC. Examples herein may refer to RNICs merely to provide illustrations of the applications of the descriptions provided herein and are not intended to limit the description to RNICs. In an example of one application, an RNIC may be used for low overhead communication over low latency, high bandwidth networks.

An RNIC Interface (RI) supports the RNIC Verb Specification (RDMA Protocol Verbs Specification 1.0, April, 2003) and can be embodied in a combination of one or more of hardware, firmware, and software, including for example, one or more of a network driver 122 and an I/O device 110. An RDMA Verb is an operation which an RNIC Interface is expected to be able to perform. A Verb Consumer, which may include a combination of one or more of hardware, firmware, and software, may use an RNIC Interface to set up communication to other nodes through RDMA Verbs. RDMA Verbs provide RDMA Verb Consumers the capability to control data placement, eliminate data copy operations, and reduce communications overhead and latencies by allowing one Verbs Consumer to directly place information in the memory of another Verbs Consumer, while preserving operating system and memory protection semantics.

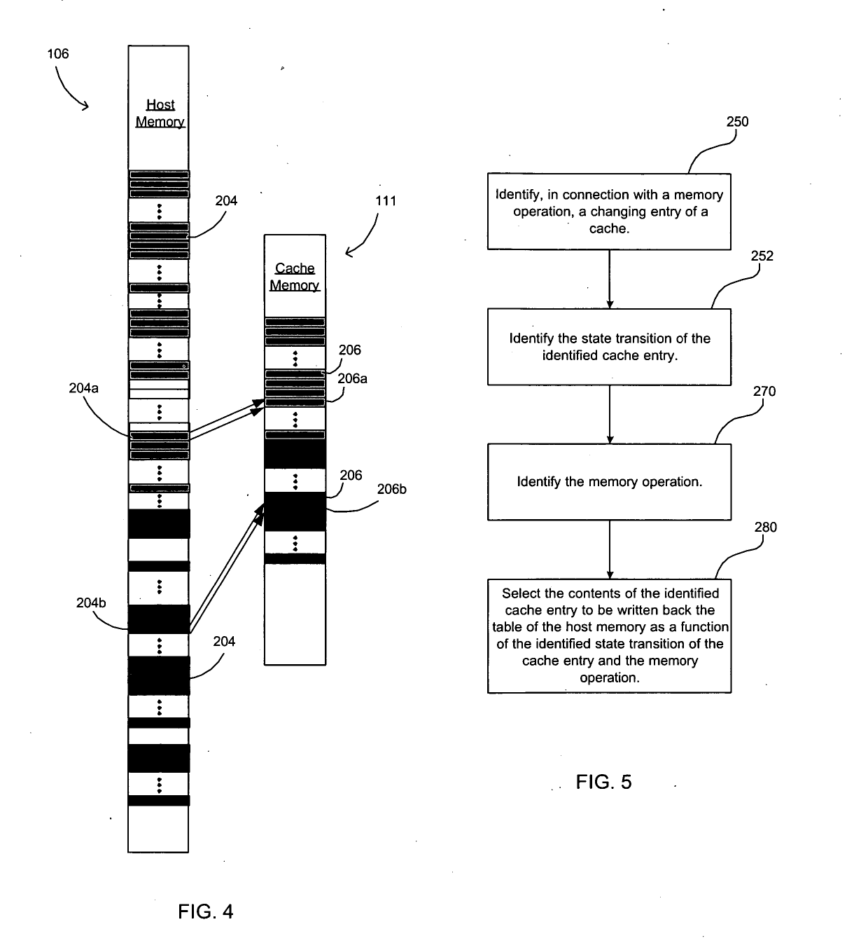

As previously mentioned, the I/O device 110 has a cache 111 which includes cache entries to store a portion of a data structure table. In accordance with one aspect of the description provided herein, changes to the data structure entries in the cache 111 are selectively written back to the source data structure table maintained in the host memory 106. For example, in the illustrated embodiment, one or both of the network driver 122 and the I/O device 110 maintains in the data structures 126 of the host memory 106, a data structure table, which in this example, is an address translation and protection table (TPT). The TPT of the host memory 106 is represented by a plurality of table entries 204 in FIG. 4.

The contents of selected entries of the entries 204 of the TPT data structures 126 in the host memory 106 may also be maintained in corresponding entries 206 of the cache 111. For example, a host memory TPT data structure entry 204a may be maintained in an I/O device cache entry 206a, a host memory TPT entry 204b may be maintained in an I/O device cache entry 206b, etc. as represented in FIG. 4 by the linking arrows. Hence, the TPT entries 204a, 204b are source entries for the cache entries 206a, 206b, respectively.

The selection of the source TPT entries 204 for caching in the cache 111 may be made using suitable heuristic techniques. These cache entry selection techniques are often designed to optimize the number of cache hits, that is, the number of instances in which TPT entries can be found stored in the cache without resorting to the host memory 106. A cache “miss” occurs when a TPT entry to be utilized by the I/O device 110 cannot be found in the cache but instead is read from the host memory 106. Thus, if the number of cache “misses” increases, then a portion of the contents of the cache 111 may be replaced with different TPT entries which are expected to provide increased cache hits. Other conditions may be monitored to determine which TPT entries from the source TPT in the host memory 106 are to be cached in the cache 111. Hence, the contents of one or more cache entries 206 may be replaced with the contents of other source TPT entries 204 of the system member 106 as conditions change.

As the I/O device processes a work request from a Verb Consumer, one or more TPT entries cached in a cache may be modified or otherwise changed. As previously mentioned, to prevent the loss of data when cache entries are subsequently replaced, some prior caching techniques utilize a write-through method in which any changes to the TPT entries in the cache are also made at the same time to the corresponding source entries of the TPT maintained in the host memory. In accordance with one aspect of the present disclosure, a selective write-back feature is provided in which changes to the contents of the TPT cache entries 206 may be written back to the corresponding source TPT entries 204 on a selective basis.

FIG. 5 shows one example of operations of an I/O device such as the an I/O device 110, to determine whether to write back the contents of a TPT cache entry 206 in connection with a memory operation. In the illustrated embodiment, the memory operations discussed herein are those that affect cache entries of a table of data structures such as a TPT, for example. It is appreciated that other types of memory operations may be utilized as well.

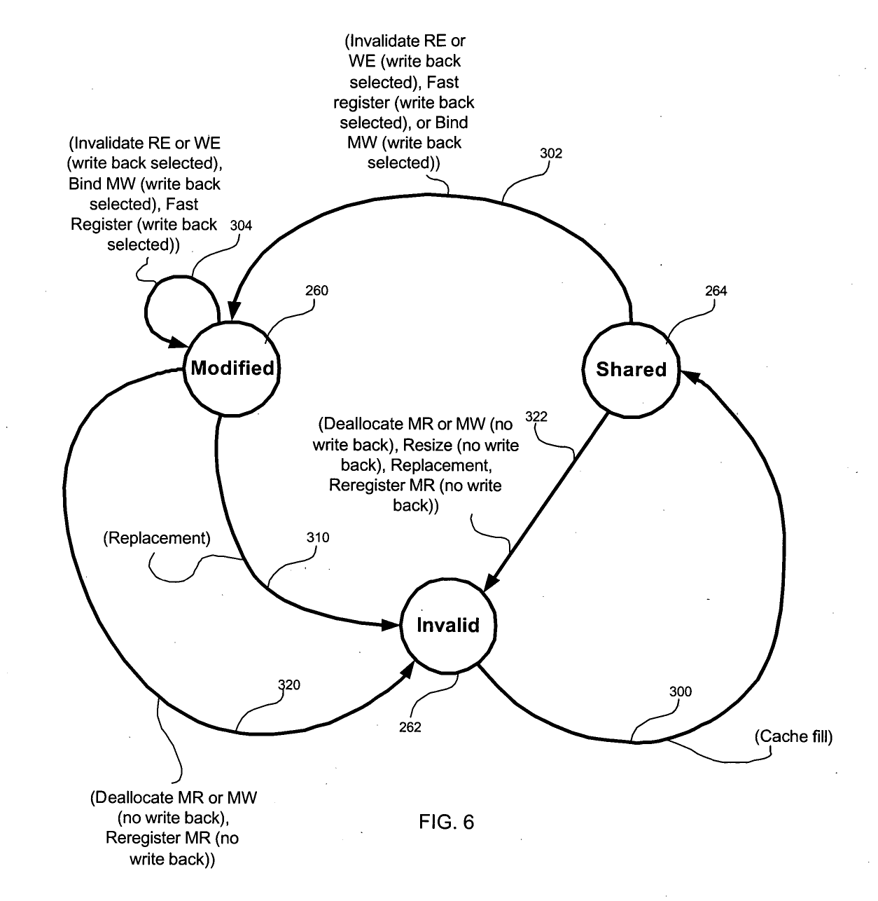

In the illustrated embodiment, the term “in connection with a memory operation” is intended to refer to operations associated with a particular memory operation and the operations may occur prior to, during or after the conducting of the memory operation itself. Accordingly, the I/O device 110 identifies (block 250) an entry of a cache, such as an entry 206 of the cache 111, the contents of which changes in connection with a memory operation. Also, the I/O device 110 identifies (block 252) the state transition of the contents of the identified cache entry. In the illustrated embodiment, a cache entry may transition among three states, designated “Modified,” “Invalid,” or “Shared,” as indicated by three states 260, 262, and 264, respectively, in the state diagram of FIG. 6. It is appreciated that, depending upon the particular application, a cache entry may have additional states, or fewer states. The states depicted in FIG. 6 are provided as an example of possible states.

Still further, the I/O device 110 identifies (block 270) the memory operation with which the change to the cache entry is associated. As previously mentioned, in the illustrated embodiment, the memory operations identified may include those that affect cache entries of a table of data structures such as a TPT, for example. In this example, the memory operations are selected RDMA verbs which affect cache entries of a TPT as set forth in Table 1 below:

TABLE 1
Exemplary RDMA Verbs

| | | Network controller | | |
|---|---|---|---|---|
| | Driver Actions affecting | actions affecting TPT | State Transition of TPT | Selective Write |
| Memory Operation | TPT in host memory | cache entries | cache entries | Back Function |
| Allocate MR | Allocate RE and TE(s); | None | Not Applicable-RE and | Not Applicable- |
| | Write RE in host memory. | | TE(s) not in cache. | |
| Allocate MW | Allocate WE and TE(s); | None | Not Applicable-WE and | Not Applicable- |
| | Write WE in host | | TE(s) not in cache. | |
| | memory. | | | |
| Register MR | Allocate RE and TE(s); | None | Not Applicable-RE and | Not Applicable- |
| | Write RE and TE(s) in | | TE(s) not in cache. | |
| | host memory. | | | |
| Cache Fill | None. | No write back performed. | Cache entry transitions to | Not Applicable. |
| | | Bring selected cache line | Shared State. | |
| | | into the cache. | | |
| Invalidate RE | None. | Write RE in cache. | RE in cache transitions to | Write back |
| | | | Modified State. | selected. |
| Remote Invalidate | None. | Write RE in cache. | RE in cache transitions to | Write back |
| RE. | | | Modified State. | selected. |
| Invalidate WE | None. | Write WE in cache. | WE in cache transitions to | Write back |
| | | | Modified State. | selected. |
| Remote Invalidate | None. | Write WE in cache. | WE in cache transitions to | Write back |
| WE | | | Modified State. | selected. |
| Replacement of a | None. | If write back selected, | Cache entry transitions | Not Applicable.. |
| cache line in | | write back line prior to | from Modified State to | |
| Modified State | | invalidation. Write | Invalid State. | |
| | | selected cache line.. | | |
| Replacement of a | None. | None. | Cache entry transitions | Not Applicable. |
| cache line in Shared | | | from Shared State to Invalid | |
| State | | | State. | |
| Deallocate MR | Free RE and TEs in host | No write back performed. | Cache entries transition to | Not Applicable. |
| | memory after successful | Invalidate TPT cache | Invalid State. | |
| | completion of | entries (RE and TE(s)). | | |
| | Administrative Command. | | | |
| Deallocate MW | Free WE and TEs in host | No write back performed. | Cache entries transition to | Not Applicable. |
| | memory after successful | Invalidate TPT cache | Invalid State. | |
| | completion of | entries (WE and TE(s)). | | |
| | Administrative Command. | | | |
| Fast Register MR | None. | Write RE and TE(s) in | RE and TE(s) in cache | Write back |
| | | cache. | transitions to Modified | selected. . |
| | | | State. | |
| Bind MW | None. | Write WE and TE(s) in | WE and TE(s) in cache | Write back |
| | | cache. | transitions to Modified | selected. |
| | | | State. | |
| Resizing QP, S-RQ, | Write new TE(s) in host | No write back performed. | Cache entries transition to | Not Applicable. |
| CQ Operations | memory. Free old TEs in | Invalidate old TPT cache | Invalid State. | |
| | host memory after | entries (TE(s)). | | |
| | successful completion of | | | |
| | Administrative Command. | | | |
| Reregister MR | Write RE and TE(s) in | None. | RE and TE(s) in cache | Not Applicable. |
| | host memory. | | transition to Invalid State. | |

Still further, the I/O device 110 selects (block 280) the contents of the identified cache entry 206 to be written back to the table of the host memory 106, as a function of the identified state of the cache memory and the identified memory operation. For example, Table 1 above indicates an RDMA Verb “Allocate MR.” As set forth in the RDMA Verb Specification, a Memory Region (MR) is an area of memory that the Consumer wants an RNIC to be able to (locally or locally and remotely) access directly in a logically contiguous fashion. The particular Memory Region is identified by the Consumer using values in accordance with the RDMA Verb Specification.

A Verb Consumer can allocate a particular Memory Region for use by presenting the Allocate Memory Region RMDA Verb to an RNIC Interface. In response, in this example, the network driver 122 can allocate the identified Memory Region by writing appropriate data structures referred to herein as Region Entries (REs) into TPT entries 204 maintained by the host memory 106. However, in the example of Table 1, an RNIC does not perform any actions affecting the entries 206 of the cache 111 in response to an Allocate Memory Region RMDA Verb. More specifically, in connection with an Allocate Memory Region memory operation, the Region Entries associated with the Allocate Memory Region memory operation are not written in cache. Accordingly, no cache entries to be changed are identified (block 250) and the state transition of the cache entries is not identified (block 252). Hence, the state diagram of FIG. 6 does not depict the Allocate Memory Region memory operation and the selective write back function is not applicable in connection with this memory operation.

Similarly, a Verb Consumer can allocate a particular Memory Window (MW) for use by presenting the Allocate Memory Window RMDA Verb to an RNIC Interface. A Memory Window is a portion of a Memory Region. In response to the Allocate Memory Window RMDA Verb, in this example, the network driver 122 allocates the identified Memory Window by writing appropriate data structures referred to herein as Window Entries (WEs) into TPT entries 204 maintained by the host memory 106. However, in the example of Table 1, an RNIC does not perform any actions affecting the entries 206 of the cache 111 in response to an Allocate Memory Window RMDA Verb. More specifically, in connection with an Allocate Memory Window memory operation, the Window Entries associated with the Allocate Memory Window memory operation are not written in cache. Accordingly, no cache entries to be changed are identified (block 250) and the state transitions of the cache entries are not identified (block 252). Hence, the state diagram of FIG. 6 does not depict the Allocate Memory Window memory operation and the selective write back function is not applicable in connection with this memory operation.

According to the RDMA Verb Specification, in order for a Memory Region to be used, the Memory Region is to be not only allocated but also registered for use by the Consumer. The Memory Registration Verb provides mechanisms that allow Consumers to register a set of virtually contiguous memory locations or a set of physically contiguous memory locations to the RNIC Interface in order to allow the RNIC to access as a virtually or physically contiguous buffer using the appropriate buffer identifier. The Memory Registration Verb provides the RNIC with a mapping between the memory location identifier provided by the Consumer and a physical memory address. It also provides the RNIC with a description of the access control associated with the memory location.

A Verb Consumer can register a particular Memory Region for use by presenting the Register Memory Region RMDA Verb to an RNIC Interface. In response, in this example, the network driver 122 registers the Memory Region by writing appropriate Region Entries and Translation Entries (TE's) into TPT entries 204 maintained by the host memory 106. However, in the example of Table 1, an RNIC does not perform any actions affecting the entries 206 of the cache 111 in response to a Register Memory Region RMDA Verb. Hence, in connection with a Register Memory Region memory operation, the Region Entries and Translation Entries associated with the Register Memory Region memory operation are not written in cache. Accordingly, no cache entries to be changed are identified (block 250) and the state transitions of the cache entries are not identified (block 252). Hence, the state diagram of FIG. 6 does not depict the Register Memory Region memory operation and the selective write back function is not applicable in connection with this memory operation.

One example of the Invalid state of a cache entry 206 is an empty cache entry 206. The RNIC Interface can fill an empty cache entry 206 with the contents of a corresponding TPT source entry 204 of the host memory 106. A cache entry state transition 300 depicts the state of a cache entry 206 changing from the Invalid state 262 to the Shared state 264 in response to a cache fill memory operation designated “cache fill” in FIG. 6. In the Shared state 264, the contents of the filled cache entry 206 are the same as the contents of the source TPT entry 204 from which the cache entry 206 was filled.

Thus, in connection with a cache fill memory operation, the cache entries 206 being filled are identified (block 250) as cache entries to be changed. The state transition of the identified cache entries 206 following the cache fill operation are identified (block 252) as to the Shared state 264. The memory operation is identified (block 270) as cache fill. In accordance with the selective write back function depicted in Table 1 and FIG. 6, the selective write back function is not applicable for this memory operation and cache entry state transition because the contents of the filled cache entry 206 are the same as the contents of the source TPT entry 204 from which the cache entry 206 was filled in the Shared state.

If access to a Memory Region or Memory Window by an RNIC Interface is not needed by the RNIC, but the Consumer wishes to retain the memory location for use in a future invocation, such as a Fast-Register or Reregister RDMA Verb as discussed below, a Consumer may directly invalidate access to the Memory Region or Memory Window through various Invalidate RDMA Verbs including Invalidate Region Entry, Remote Invalidate Region Entry, Invalidate Window Entry and Remote Invalidate Window Entry. In the example of Table 1, in each of the “Invalidate Region Entry,” Remote Invalidate Region Entry,” “Invalidate Window Entry” and “Remote Invalidate Window Entry” memory operations, the network driver 122 of the RNIC Interface does not change the TPT in host memory 106 in connection with any of these memory operations. Instead, the RNIC writes the appropriate data structures such as a Region Entry or Window Entry in the cache 111.

A cache entry state transition 302 depicts the state of a cache entry 206 changing from the Shared state 264 to the Modified state 260 in connection with one of these memory operations collectively designated “Invalidate Region Entry or Invalidate Window Entry” in FIG. 6. Another cache entry state transition 304 depicts the state of a cache entry 206 transitioning from the Modified state 260 back to the Modified state 260 in connection with one of these memory operations collectively designated “Invalidate Region Entry or Invalidate Window Entry” or “Bind MW” and “Fast Register” in FIG. 6. In the Modified state 260, the contents of the cache entry 206 are no longer the same as the contents of the corresponding source TPT entry 204. In accordance with the selective write back function depicted in Table 1 and FIG. 6, the selective write back function is applicable and a write back is selected for this Invalidate Verb memory operation and cache entry state transitions.

As previously mentioned, as conditions change, the TPT entries 204 of the host memory 106 selected for caching in the I/O device cache 111 may change in accordance with the cache entry selection technique being utilized. Hence, the contents of one or more cache entries 206 may be replaced with the contents of different source TPT entries 204 of the system memory 106, in a memory operation designated herein as “Replacement.” A cache entry state transition 310 depicts the state of a cache entry 206 changing from the Modified state 260 to the Invalid state 262 in connection with one of these memory operations designated “Replacement” in FIG. 6. In accordance with the selective write back function depicted in Table 1 and FIG. 6, a write back is performed if it was selected in a prior memory operation for that cache line as discussed above. For example, a write back may be selected for a cache line in connection with an Invalidate memory operation in which the cache line state transitions from the Shared state 264 to the Modified state 260. When the write back is performed, the modified contents of the cache entry 206 will be copied back to the corresponding source TPT entry 204. Once the contents of the cache entry 206 are copied for the write back operation, the contents of the cache entry 206 may be safely replaced with the contents of a different source TPT entry 204 without loss of TPT data.

However, a write back is not performed in connection with the Replacement operation of state transition 310 if it was not selected in a prior memory operation for that cache line. Thus, if write back was not selected, a write back is not performed prior to the contents of the cache entry 206 being replaced with the contents of a different source TPT entry 204 without loss of TPT data.

By comparison to the state transition 310, a cache entry state transition 312 depicts the state of a cache entry 206 changing from the Shared state 264 to the Invalid state 262 in connection with one of these memory operations designated “Replacement” in FIG. 6. In accordance with the selective write back function depicted in Table 1 and FIG. 6, the selective write back function is not applicable and a write back is not performed for this memory operation and cache entry state transition. Since a write back is not performed, the shared contents of the cache entry 206 are not copied back to the corresponding source TPT entry 204 before the contents of the cache entry 206 are replaced with the contents of a different source TPT entry 204. However, since the cache entry 206 is transitioning from a Shared state 264 to an Invalid state 262, loss of TPT data may be avoided since the source TPT entry 204 for the cache entry 206 previously in the Shared state 264 contains the current TPT data.

If access to a Memory Region or Window Region by an RNIC Interface is not to be used, and the Consumer does not wish to retain the memory location for a future invocation, a Consumer may deallocate an identified Memory Region or Memory Window through various Deallocate RDMA Verbs including Deallocate Memory Region, and Deallocate Memory Window. In the example of Table 1, in each of the Deallocate Memory Region, and Deallocate Memory Window memory operations, the network driver 122 of the RNIC Interface frees the appropriate data structures such as Region Entries, Window Entries or Translation Entries of the TPT maintained in the host memory 106. In addition, the RNIC invalidates the appropriate data structures such as Region Entries, Window Entries or Translation Entries in the cache 111.

A cache entry state transition 320 depicts the state of a cache entry 206 changing from the Modified state 260 to the Invalid state 262 in connection with one of these memory operations collectively designated “Deallocate MR or MW” in FIG. 6. As previously mentioned, in the Modified state 260, the contents of the cache entry 206 were no longer the same as the contents of the corresponding source TPT entry 204. Nevertheless, in accordance with the selective write back function depicted in Table 1 and FIG. 6, the selective write back function is not applicable and a write back is not performed for this memory operation and cache entry state transition because the corresponding source TPT entries 204 are freed in the course of the Deallocate RDMA Verb. Thus, a write back is not performed notwithstanding that a write back may been selected for that cache entry in a prior transition 302, 304 to the Modified state 260 as discussed above.

Another cache entry state transition 322 depicts the state of a cache entry 206 changing from the Shared state 264 to the Invalid state 262 in connection with one of these memory operations collectively designated “Deallocate MR or MW” in FIG. 6. As previously mentioned, in the Shared state 264, the contents of the cache entry 206 are the same as the contents of the corresponding source TPT entry 204. However, the cache entry 206 is invalidated in the course of the Deallocate RDMA Verb and again a write back (WB) is not performed.

Within a Memory Region or Memory Window that has already been allocated, a memory location may be registered for use by the RNIC using the Fast Register RDMA Verb. Another RDMA Verb, Bind MW, associates an identified memory location within a previously registered Memory Region to define a Memory Window. As shown in Table 1, in connection with a Fast Register or Bind MW memory operation, the network driver 122 of the RNIC Interface does not change the TPT in host memory 106 in connection with these memory operations. Instead, the RNIC writes the appropriate data structures such as a Region Entry, Window Entry or Translation Entries in the cache 111.

The cache entry state transition 304 depicts the state of a cache entry 206 transitioning from the Modified state 260 back to the Modified state 260 in connection with one of these memory operations designated “Bind MW” or “Fast Register” in FIG. 6. Similarly, a cache entry state transition 302 depicts the state of a cache entry 206 changing from Shared state 264 to the Invalid state 262 in connection with a Fast Register or Bind MW memory operation in FIG. 6. In the Modified state 260, the contents of the cache entry 206 are not the same as the contents of a corresponding source TPT entry 204. In this example, the TPT of the host memory 106 may not have corresponding source entries 206 for the cache entries 206 written in connection with these memory operations. In accordance with the selective write back function depicted in Table 1 and FIG. 6, the selective write back function is applicable and a write back is selected for either the Fast Register or Bind MW Verb memory operations and associated cache entry state transitions 302, 304. Hence, a write back may take place when the cache entry is replaced in a Replacement operation as indicated in Table 1.

As described in the RDMA Verb Specification, memory operations can be undertaken utilizing various queues including Queue Pairs (QP), Shared Request Queues (S-RQ) and Completion Queues (CQ). The queues may be resized using a Resizing RMDA Verb. The cache entry state transition 322 depicts the state of a cache entry 206 changing from the Shared state 264 to the Invalid state 262 in connection with one of these memory operations collectively designated “Resizing” in FIG. 6. As previously mentioned, in the Shared state 264, the contents of the cache entry 206 are the same as the contents of the corresponding source TPT entry 204. However, cache entries 206 are invalidated in the course of a Resizing RDMA Verb. In accordance with the selective write back function depicted in Table 1 and FIG. 6, the selective write back function is not applicable and a write back is not performed for this memory operation and cache entry state transition because the corresponding source TPT entries 204 are freed in the course of the Resizing RDMA Verb.

Another RDMA Verb is the Reregister Memory Region Verb. This Verb conceptually performs the functional equivalent of a Deallocate Verb for an identified Memory Region followed by a Register Memory Region Verb. A cache entry state transition 322 depicts the state of a cache entry 206 transitioning from the Shared state 264 to the Invalid state 262 in connection with a Reregister memory operation in FIG. 6. In the Shared state 264, the contents of the cache entry 206 are the same as the contents of a corresponding source TPT entry 204. As shown in Table 1, both the network driver 122 and the RNIC of the RNIC Interface write the appropriate data structures such as a Region Entry and Translation Entries in the host memory TPT. In accordance with the selective write back function depicted in Table 1 and FIG. 6, the selective write back function is not applicable and a write back is not performed for the Reregister Verb memory operations and associated cache entry state transitions.

A cache entry state transition 320 depicts the state of a cache entry 206 transitioning from the Modified state 260 to the Invalid state 262 in connection with a Reregister memory operation in FIG. 6. In the Modified state 264, the contents of the cache entry 206 differ from the contents of a corresponding source TPT entry 204. In accordance with the selective write back function depicted in Table 1 and FIG. 6, the selective write back function is not applicable and a write back is not performed for the Reregister Verb memory operations and associated cache entry state transitions 320, 322.

### Additional Embodiment Details

The described techniques for managing memory may be embodied as a method, apparatus or article of manufacture using standard programming and/or engineering techniques to produce software, firmware, hardware, or any combination thereof. The term “article of manufacture” as used herein refers to code or logic embodied in hardware logic (e.g., an integrated circuit chip, Programmable Gate Array (PGA), Application Specific Integrated Circuit (ASIC), etc.) or a computer readable medium, such as magnetic storage medium (e.g., hard disk drives, floppy disks, tape, etc.), optical storage (CD-ROMs, optical disks, etc.), volatile and non-volatile memory devices (e.g., EEPROMs, ROMs, PROMs, RAMs, DRAMs, SRAMs, firmware, programmable logic, etc.). Code in the computer readable medium is accessed and executed by a processor. The code in which preferred embodiments are embodied may further be accessible through a transmission media or from a file server over a network. In such cases, the article of manufacture in which the code is embodied may comprise a transmission media, such as a network transmission line, wireless transmission media, signals propagating through space, radio waves, infrared signals, etc. Thus, the “article of manufacture” may comprise the medium in which the code is embodied. Additionally, the “article of manufacture” may comprise a combination of hardware and software components in which the code is embodied, processed, and executed. Of course, those skilled in the art will recognize that many modifications may be made to this configuration without departing from the scope of the present description, and that the article of manufacture may comprise any suitable information bearing medium.

An I/O device in accordance with embodiments described herein may include a network controller or adapter or a storage controller or other devices utilizing a cache.

In the described embodiments, certain or portions of operations were described as being performed by the operating system 118, system host 112, device driver 120, or the I/O device 110. In alterative embodiments, operations or portions of operations described as performed by one of these may be performed by one or more of the operating system 118, device driver 120, or the I/O device 110. For example, memory operations or portions of memory operations described as being performed by the driver may be performed by the host. In the described embodiments, a transport protocol layer and one or more RDMA protocol layers were embodied in the I/O device 110 hardware. In alternative embodiments, one or more of these protocol layer may be embodied in the device driver 120 or operating system 118.

In certain embodiments, the device driver and network controller embodiments may be included in a computer system including a storage controller, such as a SCSI, Integrated Drive Electronics (IDE), Redundant Array of Independent Disk (RAID), etc., controller, that manages access to a non-volatile storage device, such as a magnetic disk drive, tape media, optical disk, etc. In alternative embodiments, the network controller embodiments may be included in a system that does not include a storage controller, such as certain hubs and switches.

In certain embodiments, the device driver and network controller embodiments may be embodied in a computer system including a video controller to render information to display on a monitor coupled to the computer system including the device driver and network controller, such as a computer system comprising a desktop, workstation, server, mainframe, laptop, handheld computer, etc. Alternatively, the network controller and device driver embodiments may be embodied in a computing device that does not include a video controller, such as a switch, router, etc.

In certain embodiments, the network controller may be configured to transmit data across a cable connected to a port on the network controller. Alternatively, the network controller embodiments may be configured to transmit data over a wireless network or connection, such as wireless LAN, Bluetooth, etc.

The illustrated logic of FIG. 5 shows certain events occurring in a certain order. In alternative embodiments, certain operations may be performed in a different order, modified or removed. Moreover, operations may be added to the above described logic and still conform to the described embodiments. Further, operations described herein may occur sequentially or certain operations may be processed in parallel. Yet further, operations may be performed by a single processing unit or by distributed processing units.

Details on the TCP protocol are described in “Internet Engineering Task Force (IETF) Request for Comments (RFC) 793,” published September 1981, details on the IP protocol are described in “Internet Engineering Task Force (IETF) Request for Comments (RFC) 791, published September 1981, and details on the RDMA protocol are described in the technology specification “Architectural Specifications for RDMA over TCP/IP” Version 1.0 (October 2003).

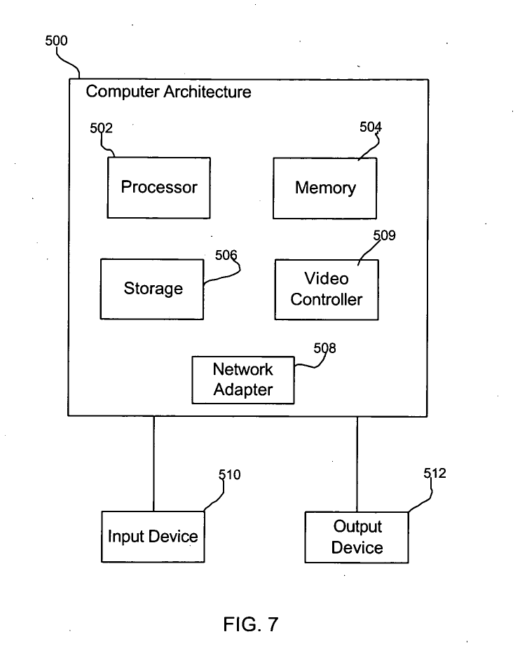

FIG. 7 illustrates one embodiment of a computer architecture 500 of the network components, such as the hosts and storage devices shown in FIG. 4. The architecture 500 may include a processor 502 (e.g., a microprocessor), a memory 504 (e.g., a volatile memory device), and storage 506 (e.g., a non-volatile storage, such as magnetic disk drives, optical disk drives, a tape drive, etc.). The storage 506 may comprise an internal storage device or an attached or network accessible storage. Programs in the storage 506 are loaded into the memory 504 and executed by the processor 502 in a suitable manner. The architecture further includes a network controller 508 to enable communication with a network, such as an Ethernet, a Fibre Channel Arbitrated Loop, etc. Further, the architecture may, in certain embodiments, include a video controller 509 to render information on a display monitor, where the video controller 509 may be embodied on a video card or integrated on integrated circuit components mounted on the motherboard. As discussed, certain of the network devices may have multiple network cards or controllers. An input device 510 is used to provide user input to the processor 502, and may include a keyboard, mouse, pen-stylus, microphone, touch sensitive display screen, or any other suitable activation or input mechanism. An output device 512 is capable of rendering information transmitted from the processor 502, or other component, such as a display monitor, printer, storage, etc.

The network controller 508 may embodied on a network card, such as a Peripheral Component Interconnect (PCI) card, PCI-express, or some other I/O card, or on integrated circuit components mounted on the motherboard. Details on the PCI architecture are described in “PCI Local Bus, Rev. 2.3”, published by the PCI-SIG. Details on the Fibre Channel architecture are described in the technology specification “Fibre Channel Framing and Signaling Interface”, document no. ISO/IEC AWI 14165-25.

The storage 108 may comprise an internal storage device or an attached or network accessible storage. Programs in the storage 108 are loaded into the memory 106 and executed by the CPU 104. An input device 152 and an output device 154 are connected to the host computer 102. The input device 152 is used to provide user input to the CPU 104 and may be a keyboard, mouse, pen-stylus, microphone, touch sensitive display screen, or any other suitable activation or input mechanism. The output device 154 is capable of rendering information transferred from the CPU 104, or other component, at a display monitor, printer, storage or any suitable output mechanism.

The foregoing description of various embodiments has been presented for the purposes of illustration and description. It is not intended to be exhaustive or to limit to the precise form disclosed. Many modifications and variations are possible in light of the above teaching.

What is claimed is:

1. A method, comprising:
performing at least a portion of a memory operation which affects a cache entry of a cache for a network controller and wherein said cache entry contains contents associated with contents of a first entry in a Translation and Protection Table (TPT) in a host memory;
identifying an entry of the cache to be changed in connection with said memory operation;
identifying the transition of the state of said identified cache entry in connection with said memory operation;
identifying the memory operation; and
selecting the contents of said identified cache entry to be written back to said first entry of said TPT of said host memory as a function of said identified state transition of said identified cache entry and said identified memory operation.

2. The method of claim 1 further comprising writing back the contents of said identified cache entry to said first entry of said TPT of said host memory, if the contents have been selected for write back, and replacing the contents of said identified cache entry with the contents of a second entry of said TPT table in said host memory.

3. The method of claim 2 further comprising excluding writing back the contents of said identified cache entry to said first entry of said TPT of said host memory in connection with a second memory operation, if both the second memory operation is a deallocate memory operation which deallocates a portion of said host memory allocated to said network controller, and the state transition of the second memory operation is one in which the state of the contents of the identified cache entry is invalid after said deallocate memory operation.

4. The method of claim 1 wherein said function selects the contents of said identified cache entry to be written back to said first entry of said TPT of said host memory, if both the identified memory operation is an invalidate memory operation which designates the contents of said identified cache entry as invalid, and the identified state transition is one in which the state of the contents of the identified cache entry is modified relative to the contents of said first entry of said TPT table in host memory after said invalidate memory operation.

5. The method of claim 1 further comprising excluding writing back the contents of said identified cache entry to said first entry of said TPT of said host memory in connection with a second memory operation, if the second memory operation is a replacement memory operation which replaces the contents of said identified cache entry with the contents of a second entry of said TPT table in said host memory, and the contents have not been selected for write back.

6. The method of claim 1 further comprising excluding writing back the contents of said identified cache entry to said first entry of said TPT of said host memory, if the contents have not been selected for write back.

7. The method of claim 1 further comprising excluding writing back the contents of said identified cache entry to said first entry of said TPT of said host memory in connection with a second memory operation, if both the second memory operation is a resize memory operation which resizes a queue of an Remote Direct Memory Access connection, and the state transition of the second memory operation is one in which the state of the contents of the identified cache entry is invalid after said resize memory operation.

8. The method of claim 1 wherein said function selects the contents of said identified cache entry to be written back to said first entry of said TPT of said host memory, if both the identified memory operation is a fast register memory operation which registers a pre-registered memory region for use by said network controller, and the identified state transition is one in which the state of the contents of the identified cache entry is modified relative to the contents of said first entry of said TPT table in host memory after said register memory operation.

9. The method of claim 1 wherein said function selects the contents of said identified cache entry to be written back to said first entry of said TPT of said host memory, if both the identified memory operation is a bind memory operation which binds a memory location for use by said network controller, and the identified state transition is one in which the state of the contents of the identified cache entry is modified relative to the contents of said first entry of said TPT table in host memory after said bind memory operation.

10. The method of claim 1 further comprising excluding writing back the contents of said identified cache entry to said first entry of said TPT of said host memory in connection with a second memory operation, if both the second memory operation is a reregister memory operation which reregisters a memory location for use by said network controller, and the state transition of the second memory operation is one in which the state of the contents of the identified cache entry is invalid after said reregister memory operation.

11. The method of claim 1 further comprising excluding writing back the contents of said identified cache entry to said first entry of said TPT of said host memory, if both the identified memory operation is a cache fill memory operation which replaces the contents of said identified cache entry with the contents of said first entry of said TPT table in said host memory, and the identified state transition is one in which the state of the contents of the identified cache entry is the same as the contents of said first entry of said TPT table in host memory after said cache fill memory operation.

12. A system, comprising:
at least one host memory which includes an operating system;
a motherboard;
a processor mounted on the motherboard and coupled to the memory;
an expansion card coupled to said motherboard;
a network controller mounted on said expansion card and having a cache; and
a device driver executable by the processor in the host memory for said network controller wherein the device driver is adapted to store in said host memory a Translation and Protection Table (TPT) in a plurality of entries including first and second entries, wherein the cache is adapted to maintain at least a portion of said TPT and wherein the network controller is adapted to:
perform at least a portion of a memory operation which affects a cache entry of said TPT;
identify an entry of the cache to be changed in connection with said memory operation;
identify the transition of the state of said identified cache entry in connection with said memory operation;
identify the memory operation; and
select the contents of said identified cache entry to be written back to said first entry of said TPT of said host memory as a function of said identified state transition of said identified cache entry and said identified memory operation.

13. The system of claim 12 wherein the network controller is further adapted to write back the contents of said identified cache entry to said first entry of said TPT of said host memory, if the contents have been selected for write back, and replace the contents of said identified cache entry with the contents of a second entry of said TPT table in said host memory.

14. The system of claim 12 wherein a portion of said host memory is adapted to be allocated to said network controller and wherein said network controller is further adapted to exclude writing back the contents of said identified cache entry to said first entry of said TPT of said host memory in connection with a second memory operation, if both the second memory operation is a deallocate memory operation which deallocates a portion of said host memory allocated to said network controller, and the state transition of the second memory operation is one in which the state of the contents of the identified cache entry is invalid after said deallocate memory operation.

15. The system of claim 12 wherein said function selects the contents of said identified cache entry to be written back to said first entry of said TPT of said host memory, if both the identified memory operation is an invalidate memory operation which designates the contents of said identified cache entry as invalid, and the identified state transition is one in which the state of the contents of the identified cache entry is modified relative to the contents of said first entry of said TPT table in host memory after said invalidate memory operation.

16. The system of claim 12 wherein said network controller is further adapted to exclude writing back the contents of said identified cache entry to said first entry of said TPT of said host memory in connection with a second memory operation, if the second memory operation is a replacement memory operation which replaces the contents of said identified cache entry with the contents of a second entry of said TPT table in said host memory, and the contents have not been selected for write back.

17. The system of claim 12 for use with a Remote Direct Memory Access connection wherein said host memory is adapted to maintain a queue of said Remote Direct Memory Access connection and wherein said network controller is further adapted to exclude writing back the contents of said identified cache entry to said first entry of said TPT of said host memory in connection with a second memory operation, if both the second memory operation is a resize memory operation which resizes a queue of an Remote Direct Memory Access connection, and the state transition of the second memory operation is one in which the state of the contents of the identified cache entry is invalid after said resize memory operation.

18. The system of claim 12 wherein a portion of said host memory is adapted to be pre-registered for use by said network controller and wherein said function selects the contents of said identified cache entry to be written back to said first entry of said TPT of said host memory, if both the identified memory operation is a register memory operation which registers a pre-registered memory region for use by said network controller, and the identified state transition is one in which the state of the contents of the identified cache entry is modified relative to the contents of said first entry of said TPT table in host memory after said register memory operation.

19. The system of claim 12 wherein said function selects the contents of said identified cache entry to be written back to said first entry of said TPT of said host memory, if both the identified memory operation is a bind memory operation which binds a memory location for use by said network controller, and the identified state transition is one in which the state of the contents of the identified cache entry is modified relative to the contents of said first entry of said TPT table in host memory after said bind memory operation.

20. The system of claim 12 wherein said network controller is further adapted to exclude writing back the contents of said identified cache entry to said first entry of said TPT of said host memory in connection with a second memory operation, if both the second memory operation is a reregister memory operation which reregisters a memory location for use by said network controller, and the state transition of the second memory operation is one in which the state of the contents of the identified cache entry is invalid after said reregister memory operation.

21. The system of claim 12 wherein the network controller is further adapted to exclude writing back the contents of said identified cache entry to said first entry of said TPT of said host memory, if both the identified memory operation is a cache fill memory operation which replaces the contents of said identified cache entry with the contents of said first entry of said TPT table in said host memory, and the identified state transition is one in which the state of the contents of the identified cache entry is the same as the contents of said first entry of said TPT table in host memory after said cache fill memory operation.

22. A network controller for use with a host memory adapted to maintain a Translation and Protection Table (TPT) in a plurality of entries including first and second entries, comprising:
a cache having a plurality of entries adapted to maintain at least a portion of said TPT; and
logic adapted to:
perform at least a portion of a memory operation which affects a cache entry of said cache for wherein said cache entry contains contents associated with contents of said first entry in said Translation and Protection Table (TPT) in said host memory;
identify an entry of the cache to be changed in connection with said memory operation;
identify the transition of the state of said identified cache entry in connection with said memory operation;
identify the memory operation; and
select the contents of said identified cache entry to be written back to said first entry of said TPT of said host memory as a function of said identified state transition of said identified cache entry and said identified memory operation.

23. The network controller of claim 22 wherein said logic is further adapted to write back the contents of said identified cache entry to said first entry of said TPT of said host memory, if the contents have been selected for write back, and replace the contents of said identified cache entry with the contents of a second entry of said TPT table in said host memory.

24. The network controller of claim 22 wherein a portion of said host memory is adapted to be allocated to said network controller and wherein said logic is further adapted to exclude writing back the contents of said identified cache entry to said first entry of said TPT of said host memory in connection with a second memory operation, if both the second memory operation is a deallocate memory operation which deallocates a portion of said host memory allocated to said network controller, and the state transition of the second memory operation is one in which the state of the contents of the identified cache entry is invalid after said deallocate memory operation.

25. The network controller of claim 22 wherein said function selects the contents of said identified cache entry to be written back to said first entry of said TPT of said host memory, if both the identified memory operation is an invalidate memory operation which designates the contents of said identified cache entry as invalid, and the identified state transition is one in which the state of the contents of the identified cache entry is modified relative to the contents of said first entry of said TPT table in host memory after said invalidate memory operation.

26. The network controller of claim 22 wherein said logic is further adapted to exclude writing back the contents of said identified cache entry to said first entry of said TPT of said host memory in connection with a second memory operation, if the second memory operation is a replacement memory operation which replaces the contents of said identified cache entry with the contents of a second entry of said TPT table in said host memory, and the contents have not been selected for write back.

27. The network controller of claim 22 further for use with a queue of a Remote Direct Memory Access connection wherein said logic is further adapted to exclude writing back the contents of said identified cache entry to said first entry of said TPT of said host memory in connection with a second memory operation, if both the second memory operation is a resize memory operation which resizes a queue of an Remote Direct Memory Access connection, and the state transition of the second memory operation is one in which the state of the contents of the identified cache entry is invalid after said resize memory operation.

28. The network controller of claim 22 wherein a portion of said host memory is adapted to be pre-registered for use by said network controller and wherein said function selects the contents of said identified cache entry to be written back to said first entry of said TPT of said host memory, if both the identified memory operation is a register memory operation which registers a pre-registered memory region for use by said network controller, and the identified state transition is one in which the state of the contents of the identified cache entry is modified relative to the contents of said first entry of said TPT table in host memory after said register memory operation.

29. The network controller of claim 22 wherein said function selects the contents of said identified cache entry to be written back to said first entry of said TPT of said host memory, if both the identified memory operation is a bind memory operation which binds a memory location for use by said network controller, and the identified state transition is one in which the state of the contents of the identified cache entry is modified relative to the contents of said first entry of said TPT table in host memory after said bind memory operation.

30. The network controller of claim 22 wherein said logic is further adapted to exclude writing back the contents of said identified cache entry to said first entry of said TPT of said host memory in connection with a second memory operation, if both the second memory operation is a reregister memory operation which reregisters a memory location for use by said network controller, and the state transition of the second memory operation is one in which the state of the contents of the identified cache entry is invalid after said reregister memory operation.

31. The network controller of claim 22 wherein the logic is further adapted to exclude writing back the contents of said identified cache entry to said first entry of said TPT of said host memory, if both the identified memory operation is a cache fill memory operation which replaces the contents of said identified cache entry with the contents of said first entry of said TPT table in said host memory, and the identified state transition is one in which the state of the contents of the identified cache entry is the same as the contents of said first entry of said TPT table in host memory after said cache fill memory operation.

32. An article for use with a cache having a plurality of entries adapted to maintain at least a portion of a Translation and Protection Table (TPT) in a plurality of entries including first and second entries maintained in a host memory, said article comprising a storage medium, the storage medium comprising machine readable instructions stored thereon to:
perform at least a portion of a memory operation which affects a cache entry of said TPT;
identify a cache entry to be changed in connection with said memory operation;
identify the transition of the state of said identified cache entry in connection with said memory operation;
identify the memory operation; and
select the contents of said identified cache entry to be written back to said first entry of said TPT of said host memory as a function of said identified state transition of said identified cache entry and said identified memory operation.

33. The article of claim 32 wherein the storage medium further comprises machine readable instructions stored thereon to write back the contents of said identified cache entry to said first entry of said TPT of said host memory, if the contents have been selected for write back, and replace the contents of said identified cache entry with the contents of a second entry of said TPT table in said host memory.

34. The article of claim 32 further for use with a network controller and wherein a portion of said host memory is adapted to be allocated to said network controller and wherein the storage medium further comprises machine readable instructions stored thereon to exclude writing back the contents of said identified cache entry to said first entry of said TPT of said host memory in connection with a second memory operation, if both the second memory operation is a deallocate memory operation which deallocates a portion of said host memory allocated to said network controller, and the state transition of the second memory operation is one in which the state of the contents of the identified cache entry is invalid after said deallocate memory operation.

35. The article of claim 32 wherein said function selects the contents of said identified cache entry to be written back to said first entry of said TPT of said host memory, if both the identified memory operation is an invalidate memory operation which designates the contents of said identified cache entry as invalid, and the identified state transition is one in which the state of the contents of the identified cache entry is modified relative to the contents of said first entry of said TPT table in host memory after said invalidate memory operation.

36. The article of claim 32 wherein the storage medium further comprises machine readable instructions stored thereon to exclude writing back the contents of said identified cache entry to said first entry of said TPT of said host memory in connection with a second memory operation, if the second memory operation is a replacement memory operation which replaces the contents of said identified cache entry with the contents of a second entry of said TPT table in said host memory, and the contents have not been selected for write back.

37. The article of claim 32 further for use with a queue of a Remote Direct Memory Access connection wherein the storage medium further comprises machine readable instructions stored thereon to exclude writing back the contents of said identified cache entry to said first entry of said TPT of said host memory in connection with a second memory operation, if both the second memory operation is a resize memory operation which resizes a queue of an Remote Direct Memory Access connection, and the state transition of the second memory operation is one in which the state of the contents of the identified cache entry is invalid after said resize memory operation.

38. The article of claim 32 further for use with a network controller and wherein a portion of said host memory is adapted to be pre-registered for use by said network controller and wherein said function selects the contents of said identified cache entry to be written back to said first entry of said TPT of said host memory, if both the identified memory operation is a register memory operation which registers a pre-registered memory region for use by said network controller, and the identified state transition is one in which the state of the contents of the identified cache entry is modified relative to the contents of said first entry of said TPT table in host memory after said register memory operation.

39. The article of claim 32 further for use with a network controller and wherein said function selects the contents of said identified cache entry to be written back to said first entry of said TPT of said host memory, if both the identified memory operation is a bind memory operation which binds a memory location for use by said network controller, and the identified state transition is one in which the state of the contents of the identified cache entry is modified relative to the contents of said first entry of said TPT table in host memory after said bind memory operation.

40. The article of claim 32 further for use with a network controller and wherein the storage medium further comprises machine readable instructions stored thereon to exclude writing back the contents of said identified cache entry to said first entry of said TPT of said host memory in connection with a second memory operation, if both the second memory operation is a reregister memory operation which reregisters a memory location for use by said network controller, and the state transition of the second memory operation is one in which the state of the contents of the identified cache entry is invalid after said reregister memory operation.

41. The article of claim 32 wherein the storage medium further comprises machine readable instructions stored thereon to exclude writing back the contents of said identified cache entry to said first entry of said TPT of said host memory, if both the identified memory operation is a cache fill memory operation which replaces the contents of said identified cache entry with the contents of said first entry of said TPT table in said host memory, and the identified state transition is one in which the state of the contents of the identified cache entry is the same as the contents of said first entry of said TPT table in host memory after said cache fill memory operation.
